(19) United States
(12) Patent Application Publication
(10) Pub. No.: US 2012/0127144 A1
(43) Pub. Date: May 24, 2012

(54) LIQUID CRYSTAL DISPLAY AND SOURCE DRIVING APPARATUS AND DRIVING METHOD OF PANEL THEREOF

(75) Inventor: Zhi-Hao Sun, Taipei County (TW)

(73) Assignee: AU OPTRONICS CORPORATION, Hsinchu (TW)

(21) Appl. No.: 13/095,911

(22) Filed: Apr. 28, 2011

(30) Foreign Application Priority Data
Nov. 18, 2010 (TW) 99139733

(51) Int. Cl. G09G 3/36; G06F 3/038

(52) U.S. Cl. 345/209; 345/96

(57) ABSTRACT

A liquid crystal display (LCD) and a source driving apparatus and a driving method of a panel thereof are provided. In the present invention, two data strings with matched driving polarities are selected to perform charge-sharing, before pixels are driven by output buffers of the source driving apparatus. Accordingly, the power consumed by the output buffers of the source driving apparatus would be lower during the process of driving pixels, and thus achieving the purpose of power saving.

### CROSS-REFERENCE TO RELATED APPLICATION

This application claims the priority benefit of Taiwan application serial no. 99139733, filed Nov. 18, 2010. The entirety of the above-mentioned patent application is hereby incorporated by reference herein and made a part of this specification.

### BACKGROUND OF THE INVENTION

1. Field of the Invention

The present invention generally relates to a flat panel display technology, in particular, to a liquid crystal display (LCD) and a source driving apparatus and a driving method of a panel thereof.

2. Description of Related Art

Low-temperature polysilicon (LTPS) is a manufacturing process for a thin film transistor liquid crystal display (TFT-LCD) of a new generation. Compared with a conventional amorphous-silicon (Si) display, an LCD panel manufactured through the LTPS not only has a quick reaction speed, but also has a high brightness, a high resolution, and other advantages.

FIG. 1 is a schematic view of driving a conventional LTPS TFT-LCD. Referring to FIG. 1, during a disable period of a scan signal GP received by a scan line SL, an output buffer Buf of a source driving apparatus of the conventional LTPS TFT-LCD may output three data signals to data lines DL1-DL3 timingly/in sequence in response to operation of a multiplexer MUX, thereby correspondingly driving pixels R, G, and B to display red color image, green color image, and blue color image respectively.

More clearly, selection signals S1-S3 respectively received by three selection ends of the multiplexer MUX may be triggered in sequence at a falling edge of a load signal XSTB. When the select signal S1 is triggered, the output buffer Buf of the source driving apparatus may provide the corresponding data signal to the data line DL1 through the multiplexer MUX, thereby driving the pixel R; when the select signal S2 is triggered, the output buffer Buf of the source driving apparatus may provide the corresponding data signal to the data line DL2 through the multiplexer MUX, thereby driving the pixel G; and when the select signal S3 is triggered, the output buffer Buf of the source driving apparatus may provide the corresponding data signal to the data line DL3 through the multiplexer MUX, thereby driving the pixel B.

For a driving manner of dot inversion or column inversion, during a period of an N^{th} frame period of the LTPS TFT-LCD, driving polarities of the data signals provided to the data lines DL1-DL3 are, for example, positive (+), negative (−), and positive (+) respectively, and during a period of an (N+1)^{th} frame period of the LTPS TFT-LCD, the driving polarities of the data signals provided to the data lines DL1-DL3 are converted to, for example, negative (−), positive (+), and negative (−) respectively. In other words, during periods of two neighboring frame periods of the LTPS TFT-LCD, the driving polarities of the data signals provided to the data lines DL1-DL3 are converted from positive (+) to negative (−), or from negative (−) to positive (+). It is known that the power consumed by the output buffer Buf of the source driving apparatus is higher during the process of driving the pixels R, G, and B.

### SUMMARY OF THE INVENTION

Accordingly, the present invention is directed to an LCD and a source driving apparatus and a driving method of a panel thereof, capable of lowering a power consumed by output buffers of the source driving apparatus during a process of driving pixels.

The present invention provides a source driving apparatus, which includes a signal processing body, at least two buffers, and at least one switch. The signal processing body is used to provide at least two data strings, in which each data string has a plurality of data signals, a half of all data signals in the two data strings respectively correspond to a positive driving polarity, and the other half of all the data signals in the two data strings respectively correspond to a negative driving polarity. The two buffers are coupled to the signal processing body, for respectively receiving and outputting the two data strings in response to a load signal. The switch is coupled between output ends of the two buffers, for being turned on in response to the load signal before the two buffers output the two data strings.

The present invention also provides an LCD, which includes an LCD panel and the provided source driving apparatus.

The present invention further provides a method for driving an LCD panel, and which includes generating at least two data strings, in which each data string includes a plurality of data signals, a half of all data signals in the two data strings respectively correspond to a positive driving polarity, and the other half of all the data signals in the two data strings respectively correspond to a negative driving polarity; respectively receiving and outputting the two data strings by two buffers in response to a load signal; and connecting output ends of the two buffers in response to the load signal before the two data strings are output.

In view of the above mentioned, in the present invention, two data strings with matched driving polarities are selected to perform charge-sharing, before pixels are driven by output buffers of a source driving apparatus. Accordingly, the power consumed by the output buffers of the source driving apparatus would be lower during the process of driving pixels, and thus achieving the purpose of power saving.

It should be understood that the above description and the embodiments in the following are only exemplary and illustrative, without limiting the claims of the present invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of driving a conventional LTPS TFT-LCD.

FIG. 2 is a schematic system view of an LCD according to an embodiment of the present invention.

FIG. 3 is a schematic view of driving an LCD panel 201 according to an embodiment of the present invention.

FIG. 4 is a schematic system view of an LCD 40 according to another embodiment of the present invention.

FIG. 5 is a schematic view of processes of a method for driving an LCD panel according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

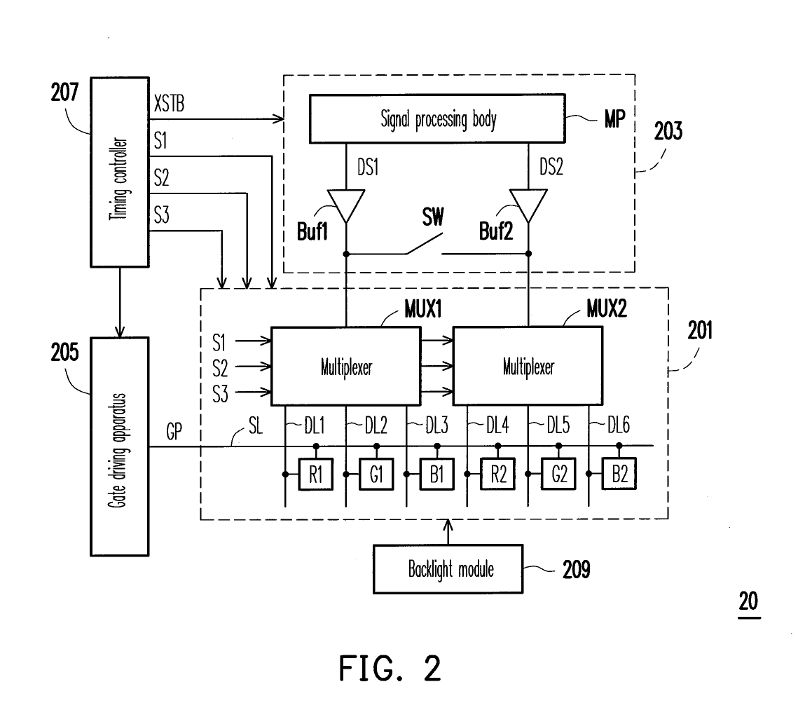

FIG. 2 is a schematic system view of an LCD 20 according to an embodiment of the present invention. Referring to FIG. 2, the LCD 20 includes an LCD panel 201, a source driving apparatus 203, a gate driving apparatus 205, a timing controller (T-con) 207, and a backlight module 209. The LCD panel 201 is preferably an LTPS LCD panel, but not limited thereto.

In this embodiment, the source driving apparatus 203 is coupled to the LCD panel 201, and includes a signal processing body MP, at least two buffers Buf1 and Buf2, and at least one switch SW. The signal processing body MP is used to provide at least two data strings DS1 and DS2, in which each of the data string DS1 and DS2 has a plurality of data signals. A half of all data signals in the data strings DS1 and DS2 respectively correspond to a positive driving polarity, and the other half of all the data signals in the two data strings respectively correspond to a negative driving polarity.

The buffers Buf1 and Buf2 are coupled to the signal processing body MP, for respectively receiving and outputting the data strings DS1 and DS2 in response to a rising edge or a falling edge of a load signal XSTB provided by the T-con 207. In other words, the signal processing body MP may respectively provide the data strings DS1 and DS2 to the buffers Buf1 and Buf2 in response to the rising edge or the falling edge of the load signal XSTB provided by the T-con 207. Further, the switch SW is coupled between output ends of the buffers Buf1 and Buf2, for being turned on in response to an initial enable period (IEP) of the load signal XSTB provided by the T-con 207 before the buffers Buf1 and Buf2 output the data strings DS1 and DS2.

In another aspect, the LCD panel 201 includes at least one scan line SL, a plurality of data lines (for ease of description, only 6 data lines DL1-DL6 are shown), a plurality of pixels (for ease of description, only 6 pixels R1, G1, B1, R2, G2, and B2 of the same row are shown), and at least two multiplexers MUX1 and MUX2. It may be clearly seen from FIG. 2 that the pixels R1, G1, B1, R2, G2, and B2 are coupled to the scan line SL and the respective data lines DL1-DL6, wherein the pixels R1 and R2 are corresponding to, for example, red color; the pixels G1 and G2 are corresponding to, for example, green color; and the pixels B1 and B2 are corresponding to, for example, blue color. Further, the multiplexers MUX1 and MUX2 are coupled to the buffers Buf1 and Buf2 and the data lines DL1-DL6, for coordinating with the buffers Buf1 and Buf2 to transmit each data signal of the data strings DS1 and DS2 output by the buffers Buf1 and Buf2 to the corresponding data lines DL1-DL6.

In addition, the gate driving apparatus 205 is coupled to the LCD panel 201, for providing a scan signal GP to the scan line SL. Furthermore, the T-con 207 is coupled to the source driving apparatus 203 and the gate driving apparatus 205, for at least providing the load signal XSTB to the source driving apparatus 203, and coordinately controlling operation of the source driving apparatus 203 and operation of the gate driving apparatus 205. In addition, the backlight module 209 is used to provide a backlight source required by the LCD panel 201.

Here, if the LCD panel 201 is driven in a driving manner of dot inversion or column inversion, it represents that during a period of an N^{th} frame period of the LCD 20, the signal processing body MP needs to provide the data string DS1 having 3 data signals with driving polarities being, for example, positive (+), negative (−), and positive (+) respectively, and provide the data string DS2 having 3 data signals with driving polarities being negative (−), positive (+), and negative (−) respectively. Next, during a period of an N+1)^{th} frame period of the LCD 20, the signal processing body MP needs to provide the data string DS1 having 3 data signals with the driving polarities being negative (−), positive (+), and negative (−) respectively, and provide the data string DS2 having 3 data signals with the driving polarities being positive (+), negative (−), and positive (+) respectively.

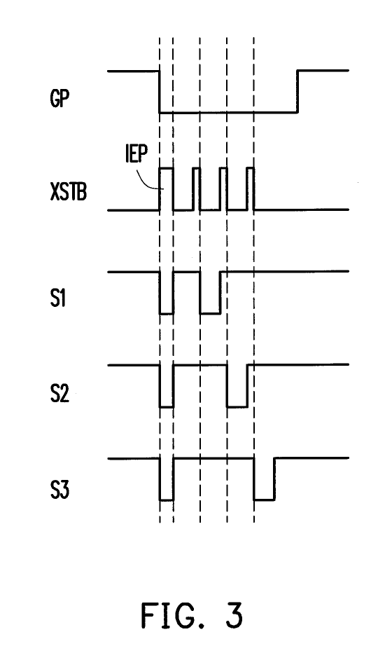

Accordingly, FIG. 3 is a schematic view of driving the LCD panel 201 according to an embodiment of the present invention. Referring to FIGS. 2 and 3, during a disable period of the scan signal GP received by the scan line SL, the output buffer Buf1 of the source driving apparatus 203 outputs 3 data signals with the driving polarities being positive (+), negative (−), and positive (+) respectively to the data lines DL1-DL3 timingly/in sequence in response to operation of the multiplexer MUX1, thereby correspondingly driving the pixels R1, G1, and B1. Similarly, during the disable period of the scan signal GP received by the scan line SL, the output buffer Buf2 of the source driving apparatus 203 outputs 3 data signals with the driving polarities being negative (−), positive (+), and negative (−) respectively to the data lines DL4-DL6 timingly/in sequence in response to operation of the multiplexer MUX2, thereby correspondingly driving the pixels R2, G2, and B2.

More clearly, selection signals S1-S3 (provided by the T-con 207) respectively received by three selection ends of the multiplexers MUX1 and MUX2 may be triggered in sequence at the falling edge of the load signal XSTB (as shown in FIG. 3), and definitely, may also be designed to be triggered in sequence at the rising edge of the load signal XSTB, which is determined according to actual design demands. When the selection signal S1 is triggered, the output buffers Buf1 and Buf2 of the source driving apparatus 203 may respectively provide 2 data signals with the driving polarities being positive (+) and negative (−) respectively to the data lines DL1 and DL4 through the multiplexers MUX1 and MUX2, thereby correspondingly driving the pixels R1 and R2.

In addition, when the selection signal S2 is triggered, the output buffers Buf1 and Buf2 of the source driving apparatus 203 may respectively provide 2 data signals with the driving polarities being negative (−) and positive (+) respectively to the data lines DL2 and DL5 through the multiplexers MUX1 and MUX2, thereby correspondingly driving the pixels G1 and G2. Further, when the selection signal S3 is triggered, the output buffers Buf1 and Buf2 of the source driving apparatus 203 may respectively provide 2 data signals with the driving polarities being positive (+) and negative (−) respectively to the data lines DL3 and DL6 through the multiplexers MUX1 and MUX2, thereby correspondingly driving the pixels B1 and B2.

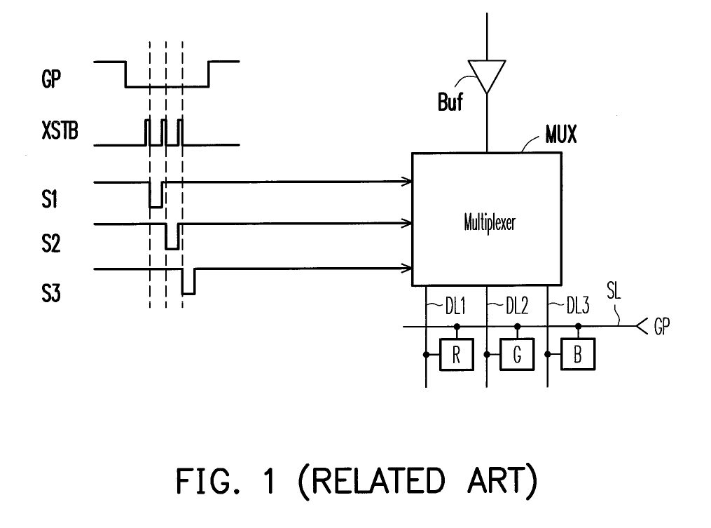

Here, please review the contents of the prior art and FIG. 1, that is, for a driving manner of dot inversion or column inversion, during a period of an N^{th} frame period of an LTPS TFT-LCD, driving polarities of data signals provided to data lines DL1-DL3 are, for example, positive (+), negative (−), and positive (+) respectively, and during a period of an (N+1)^{th} frame period of the LTPS TFT-LCD, the driving polarities of the data signals provided to the data lines DL1-DL3 are converted to, for example, negative (−), positive (+), and negative (−) respectively. In other words, during periods of two neighboring frame periods of the LTPS TFT-LCD, the driving polarities of the data signals provided to the data lines DL1-DL3 are converted from positive (+) to negative (−), or from negative (−) to positive (+). It is known that the power consumed by the output buffer Buf of the source driving apparatus is higher during the process of driving the pixels R, G, and B.

In view of the above mentioned, in order to solve the problem, in this embodiment, when the LCD 20 enters from the period of the N^{th} frame period to the period of the (N+1)^{th} frame period, and before driving the pixels R1, G1, B1, R2, G2, and B2 by the output buffers Buf1 and Buf2 of the source driving apparatus 203, the switch SW may be turned on in response to the IEP of the load signal XSTB (a control signal of the switch SW may be obtained after the selection signal S1 is reversed and an AND operation is performed on the reversed selection signal S1 and the load signal XSTB), such that the output ends of the buffers Buf1 and Buf2 are connected together. Meanwhile, the selection signals S1-S3 are triggered simultaneously, so that input ends and output ends of the multiplexers MUX1 and MUX2 are connected to the output ends of the buffers Buf1 and Buf2 connected together.

Furthermore, the pixels R1, G1, B1, R2, G2, and B2 are turned on/enabled at the this time, such that charges stored in the pixels R1, G1, B1, R2, G2, and B2 during the period of the N^{th} frame period of the LCD 20 may be shared, and a neutralized result of the charges may be up to an intermediate level. Therefore, when the output buffers Buf1 and Buf2 of the source driving apparatus 203 drive the pixels R1, G1, B1, R2, G2, and B2, the driving starts from the intermediate level to the level being partial to the positive driving polarity or the negative driving polarity, instead of starting from the level being partial to the positive driving polarity to the level being partial to the negative driving polarity, or from the level being partial to the negative driving polarity to the level being partial to the positive driving polarity in old days. It can be known that the power consumed by the output buffers Buf1 and Buf1 of the source driving apparatus 203 would be lower during the process of driving the pixels R1, G1, B1, R2, G2, and B2, and thus achieving the purpose of power saving.

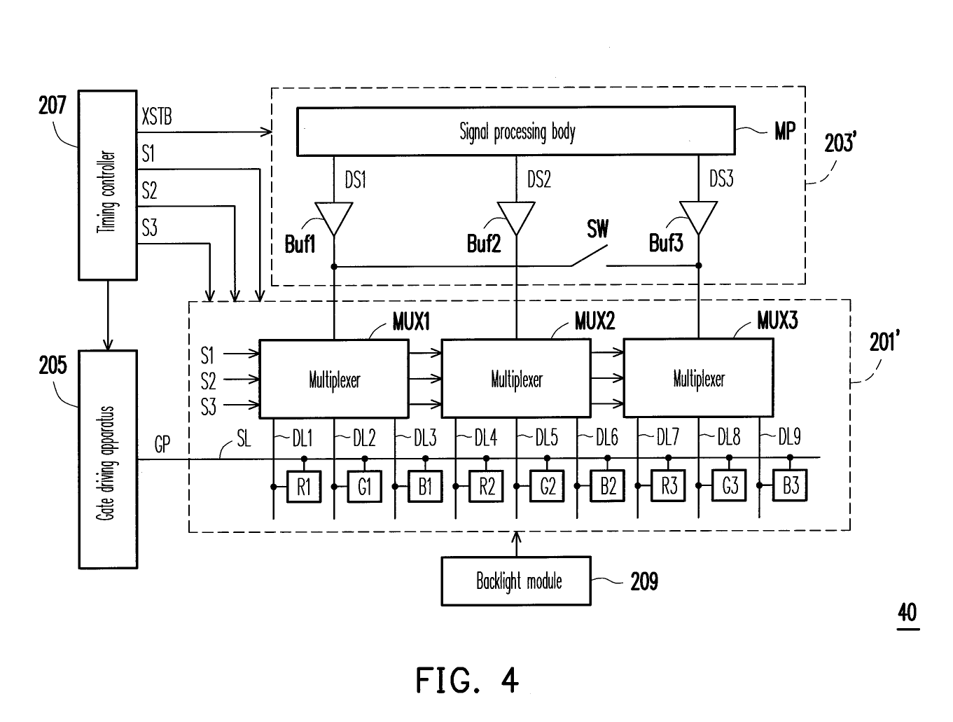

In addition, FIG. 4 is schematic system view of an LCD 40 according to another embodiment of the present invention. Referring to FIGS. 2 and 4, the LCD 40 includes an LCD panel 201′, a source driving apparatus 203′, a gate driving apparatus 205, a T-con 207, and a backlight module 209. The difference between the LCD 40 of FIG. 4 and the LCD 20 of FIG. 2 is that the LCD 40 of FIG. 4 is suitable to be driven in a driving manner being two dot inversion or two column inversion. Therefore, a buffer Buf3 is added to the source driving apparatus 203′, and the switch SW is changed to be coupled between the buffers Buf1 and Buf3. In addition, a multiplexer MUX3, 3 data lines DL7-DL9, and 3 pixels R3, G3, and B3 are added to the LCD panel 201′.

Herein, the LCD panel 201′ is driven in the driving manner of two dot inversion or two column inversion, such that during a period of an N^{th} frame period of the LCD 40, a signal processing body MP needs to provide a data string DS1 having 3 data signals with driving polarities being, for example, positive (+), positive (+), and negative (−) respectively, provide a data string DS2 having 3 data signals with driving polarities being negative (−), positive (+), and positive (+) respectively, and provide a data string DS3 having 3 data signals with driving polarities being negative (−), negative (−), and positive (+) respectively. Next, during a period of an (N+1)^{th} frame period of the LCD 40, the signal processing body MP needs to provide the data string DS1 having 3 data signals with the driving polarities being negative (−), negative (−), and positive (+) respectively, provide the data string DS2 having 3 data signals with the driving polarities being positive (+), negative (−), and negative (−) respectively, and provide the data string DS3 having 3 data signals with driving polarities being positive (+), positive (+), and negative (−) respectively.

Similarly, a schematic view of driving the LCD panel 201′ is as shown in FIG. 3. Referring to FIGS. 3 and 4, during a disable period of a scan signal GP received by a scan line SL, the output buffer Buf1 of the source driving apparatus 203′ outputs 3 data signals with the driving polarities being positive (+), positive (+), and negative (−) respectively to the data lines DL1-DL3 timingly/in sequence in response to operation of the multiplexer MUX1, thereby correspondingly driving the pixels R1, G1, and B1. In addition, during the disable period of the scan signal GP received by the scan line SL, the output buffer Buf2 of the source driving apparatus 203′ outputs 3 data signals with the driving polarities being negative (−), positive (+), and positive (+) respectively to the data lines DL4-DL6 timingly/in sequence in response to operation of the multiplexer MUX2, thereby correspondingly driving the pixels R2, G2, and B2. Further, during the disable period of the scan signal GP received by the scan line SL, the output buffer Buf3 of the source driving apparatus 203′ outputs 3 data signals with the driving polarities being negative (−), negative (−), and positive (+) respectively to the data lines DL7-DL9 timingly/in sequence in response to operation of the multiplexer MUX3, thereby correspondingly driving the pixels R3, G3, and B3.

More clearly, selection signals S1-S3 (provided by the T-con 207) respectively received by three selection ends of the multiplexers MUX1-MUX3 may be triggered in sequence at a falling edge of a load signal XSTB (as shown in FIG. 3), and definitely, may also be designed to be triggered in sequence at a rising edge of the load signal XSTB, which is determined according to actual design demands. When the selection signal S1 is triggered, the output buffers Buf1-Buf3 of the source driving apparatus 203′ may respectively provide 3 data signals with the driving polarities being positive (+), negative (−), and negative (−) respectively to the data lines DL1, DL4, and DL7 through the multiplexers MUX1-MUX3, thereby correspondingly driving the pixels R1-R3.

In addition, when the selection signal S2 is triggered, the output buffers Buf1-Buf3 of the source driving apparatus 203′ may respectively provide 3 data signals with the driving polarities being positive (+), positive (+), and negative (−) respectively to the data lines DL2, DL5, and DL8 through the multiplexers MUX1-MUX3, thereby correspondingly driving the pixels G1-G3. Further, when the selection signal S3 is triggered, the output buffers Buf1-Buf3 of the source driving apparatus 203′ may respectively provide 3 data signals with the driving polarities being negative (−), positive (+), and positive (+) respectively to the data lines DL3, DL6, and DL9 through the multiplexers MUX1-MUX3, thereby correspondingly driving the pixels B1-B3.

Similarly, when the LCD 40 enters from the period of the N^{th} frame period to the period of the (N+1)^{th} frame period, and before driving the pixels R1-R3, G1-G3, and B1-B3 by the output buffers Buf1-Buf3 of the source driving apparatus 203′, the switch SW may be turned on in response to an IEP of the load signal XSTB (a control signal of the switch SW may be obtained after the selection signal S1 is reversed and an AND operation is performed on the reversed selection signal S1 and the load signal XSTB), such that the output ends of the buffers Buf1 and Buf3 are connected together. Meanwhile, the selection signals S1-S3 are triggered simultaneously, so that input ends and output ends of the multiplexers MUX1 and MUX3 are connected to the output ends of the buffers Buf1 and Buf3 connected together. In this manner, the similar purpose of power saving is achieved as the previous embodiment.

It can be known that in the above embodiments, the two data strings with the matched driving polarities are selected to perform charge-sharing, before the pixels are driven by the output buffers of the source driving apparatus. That is to say, the two data strings having the same number of the positive driving polarities and the same number of the negative driving polarities perform the charge-sharing. Accordingly, the power consumed by the output buffers of the source driving apparatus would be lower during the process of driving the pixels.

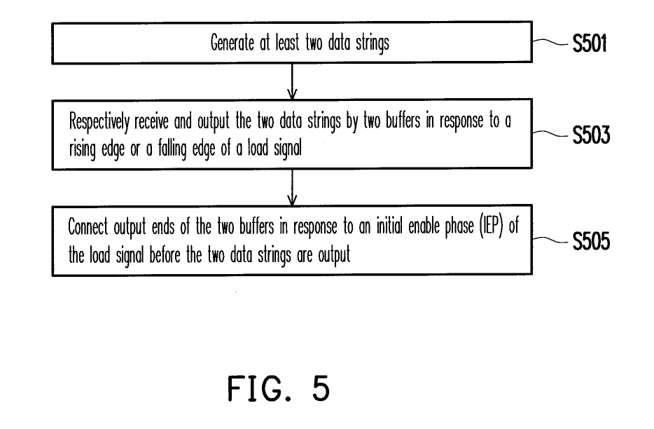

Based on the above mentioned contents in the above embodiments, FIG. 5 is a schematic view of processes of a method for driving an LCD panel according to an embodiment of the present invention. Referring to FIG. 5, the method of this embodiment includes generating at least two data strings (Step S501), in which each data string includes a plurality of data signals, a half of all data signals in the two data strings respectively correspond to a positive driving polarity, and the other half of all the data signals in the two data strings respectively correspond to a negative driving polarity; respectively receiving and outputting the two data strings by two buffers in response to a rising edge or a falling edge of a load signal (Step S503); and connecting output ends of the two buffers in response to an IEP of the load signal before the two data strings are output (Step S505).

In view of the above mentioned, in the present invention, the two data strings with the matched driving polarities are selected to perform charge-sharing, before the pixels are driven by the output buffers of the source driving apparatus. Accordingly, the power consumed by the output buffers of the source driving apparatus would be lower during the process of driving the pixels, and thus achieving the purpose of power saving.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents. Further, any embodiment or claim of the present invention does not have to achieve all the disclosed functions, advantages, or features. In addition, the abstract and title are only used to assist the reference of the patent document, instead of limiting the claims of the present invention.

What is claimed is:

1. A source driving apparatus, comprising:
a signal processing body, for providing at least two data strings, wherein each data string comprises a plurality of data signals;
at least two buffers, coupled to the signal processing body, for respectively receiving and outputting the two data strings in response to a load signal; and
at least one switch, coupled between output ends of the two buffers, for being turned on in response to the load signal before the two buffers output the two data strings,
wherein a half of all data signals in the two data strings respectively correspond to a positive driving polarity, and the other half of all the data signals in the two data strings respectively correspond to a negative driving polarity.

2. The source driving apparatus according to claim 1, wherein the two buffers respectively receive and output the two data strings in response to a rising edge or a falling edge of the load signal.

3. The source driving apparatus according to claim 1, wherein the switch is turned on in response to an initial enable period (IEP) of the load signal before the two buffers output the two data strings.

4. A liquid crystal display (LCD), comprising:
an LCD panel; and
a source driving apparatus, coupled to the LCD panel, and the source driving apparatus comprising:
a signal processing body, for providing at least two data strings, wherein each data string comprises a plurality of data signals;
at least two buffers, coupled to the signal processing body, for respectively receiving and outputting the two data strings in response to a load signal; and
at least one switch, coupled between output ends of the two buffers, for being turned on in response to the load signal before the two buffers output the two data strings,
wherein a half of all data signals in the two data strings respectively correspond to a positive driving polarity, and the other half of all the data signals in the two data strings respectively correspond to a negative driving polarity.

5. The LCD according to claim 4, wherein the LCD panel comprises:
at least one scan line;
a plurality of data lines;
a plurality of pixels, correspondingly coupled to the scan line and the data lines; and
at least two multiplexers, coupled to the two buffers and the data lines, for coordinating with the two buffers to transmit each data signal of the two data strings output by the two buffers to the corresponding data line.

6. The LCD according to claim 5, further comprising:
a gate driving apparatus, coupled to the LCD panel, for providing a scan signal to the scan line;
a timing controller (T-con), coupled to the source driving apparatus and the gate driving apparatus, for at least providing the load signal, and coordinately controlling operation of the source driving apparatus and operation of the gate driving apparatus; and
a backlight module, for providing a backlight source required by the LCD panel.

7. The LCD according to claim 5, wherein the LCD panel is a low-temperature polysilicon (LTPS) LCD panel.

8. The LCD according to claim 4, wherein the two buffers respectively receive and output the two data strings in response to a rising edge or a falling edge of the load signal.

9. The LCD according to claim 4, wherein the switch is turned on in response to an initial enable period (IEP) of the load signal before the two buffers output the two data strings.

10. A method for driving an LCD panel, comprising:
generating at least two data strings, wherein each data string comprises a plurality of data signals;
respectively receiving and outputting the two data strings by two buffers in response to a load signal; and
connecting output ends of the two buffers in response to the load signal before the two data strings are output,
wherein a half of all data signals in the two data strings respectively correspond to a positive driving polarity, and the other half of all the data signals in the two data strings respectively correspond to a negative driving polarity.

11. The method according to claim 10, wherein the two buffers respectively receive and output the two data strings in response to a rising edge or a falling edge of the load signal.

12. The method according to claim 10, wherein the output ends of the two buffers are connected together in response to an initial enable period (IEP) of the load signal.
